(19) United States
(12) Patent Application Publication
(10) Pub. No.: US 2016/0107296 A1
(43) Pub. Date: Apr. 21, 2016

(54) BASIN WRENCH

(71) Applicant: Milwaukee Electric Tool Corporation, Brookfield, WI (US)

(72) Inventors: Jesse Marcelle, Muskego, WI (US); Steven W. Hyma, Milwaukee, WI (US); Justin G. Ferrante, Wauwatosa, WI (US); Cheng Zhang Li, Sussex, WI (US); James A. Cemke, JR., Richfield, WI (US)

(21) Appl. No.: 14/884,940

(22) Filed: Oct. 16, 2015

Related U.S. Application Data
(60) Provisional application No. 62/064,714, filed on Oct. 16, 2014.

(51) Int. Cl. B25B 13/50; B25G 1/00; B25G 1/06; B25B 13/48

(52) U.S. Cl. CPC B25B 13/505; B25B 13/481; B25G 1/005; B25G 1/063

(57) ABSTRACT

A wrench includes a first jaw and a second jaw movable relative to the first jaw about a first axis. The first and the second jaws are configured to grip a work piece. The wrench also includes a body pivotally coupled to the first and the second jaws about a second axis. The body includes an interior portion, a first end, and a second end. The first end is adjacent the first and the second jaws. The second end includes an opening. The wrench further includes a cap having a first portion and a second portion. The first portion is received within the interior portion of the body through the opening. The second portion extends outside of the body and away from the opening. The second portion includes a square drive aperture configured to receive a square drive of a tool.

### CROSS-REFERENCE TO RELATED APPLICATIONS

This application claims priority to U.S. Provisional Patent Application No. 62/064,714, filed Oct. 16, 2014, the entire contents of which are incorporated by reference herein.

### BACKGROUND

The present invention relates to wrenches, and more particularly to basin wrenches.

Basin wrenches are typically used to rotate, tighten, or otherwise manipulate pipes, valves, fittings, and other plumbing components. Basin wrenches include a base jaw and a hook jaw pivotable with respect to the base jaw to adjust the spacing between the jaws. Because basin wrenches are often used to apply torque to work pieces, the jaws typically include teeth for improved grip.

### SUMMARY

In one embodiment, the invention provides a wrench including a first jaw and a second jaw movable relative to the first jaw about a first axis. The first and the second jaws are configured to grip a work piece. The wrench also includes a body pivotally coupled to the first and the second jaws about a second axis. The body includes an interior portion, a first end, and a second end. The first end is adjacent the first and the second jaws. The second end includes an opening. The wrench further includes a cap having a first portion and a second portion. The first portion is received within the interior portion of the body through the opening. The second portion extends outside of the body and away from the opening. The second portion includes a square drive aperture configured to receive a square drive of a tool.

In another embodiment, the invention provides a wrench including a first jaw and a second jaw movable relative to the first jaw about a first axis. The first and the second jaws are configured to grip a work piece. The wrench includes a body pivotally coupled to the first and the second jaws about a second axis. The body includes an interior portion, a first end, and a second end. The first end is adjacent the first and the second jaws. The second end includes an opening. The body further includes first handle apertures positioned adjacent the opening. The wrench further includes a cap having a first portion and a second portion. The first portion is received within the interior portion of the body through the opening. The first portion includes a second handle aperture. The second portion extends outside of the body and away from the opening. The wrench includes a handle received through the first and the second handle apertures to secure the cap to the body.

In yet another embodiment, the invention provides a wrench including a first jaw and a second jaw movable relative to the first jaw about a first axis. The first and the second jaws are configured to grip a work piece. The wrench also includes a body pivotally coupled to the first and the second jaws about a second axis. The body includes an interior portion, a first end, and a second end. The first end is adjacent the first and the second jaws. The second end includes an opening. The body further includes a projection adjacent the opening extending into the interior portion of the body. The wrench further includes a cap having a first portion and a second portion. The first portion is received within the interior portion of the body through the opening. The first portion includes a recess. The second portion extends outside of the body and away from the opening. Engagement between the projection and the recess secures the cap to the body.

Other features and aspects of the invention will become apparent by consideration of the following detailed description and accompanying drawings.

### BRIEF DESCRIPTION OF THE DRAWINGS

FIG. 1 is a perspective view of a wrench according to an embodiment of the invention.

FIG. 2 is an exploded view of a portion of the wrench of FIG. 1.

FIG. 3 is a cross sectional view taken along 3-3 of the wrench of FIG. 1.

FIG. 4 illustrates the wrench of FIG. 1 gripping a work piece with a socket wrench coupled to a portion of the wrench.

FIG. 5 is a perspective view of a wrench according to another embodiment of the invention.

FIG. 6 is a perspective view of an end cap of the wrench of FIG. 5.

FIG. 7 is a side view of a wrench according to an embodiment of the invention.

FIG. 8 is a side view of a wrench according to an embodiment of the invention.

FIG. 9 is a perspective view of portion of a wrench with a first hook jaw according to another embodiment of the invention.

FIG. 10 is a perspective view of the wrench of FIG. 9 with a second hook jaw.

FIG. 11 is a cross sectional view taken along 11-11 of FIG. 9 with the first and the second hook jaws removed.

FIG. 12 is a perspective view of a wrench according to another embodiment of the invention.

FIG. 13 is a cross sectional view taken along 13-13 of FIG. 12.

FIG. 14 is a perspective view of a first hook jaw coupled to a wrench according to another embodiment of the invention.

FIG. 15 is a perspective view of a second hook jaw coupled to the wrench of FIG. 14.

FIG. 16 is a perspective view of a wrench according to another embodiment of the invention.

FIG. 17 is a perspective view of a wrench according to another embodiment of the invention.

FIG. 18 is a cross sectional view taken along 18-18 of FIG. 17.

FIG. 19 is a perspective view of a wrench according to another embodiment of the invention.

FIG. 20 is a cross sectional view taken along 20-20 of FIG. 19.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

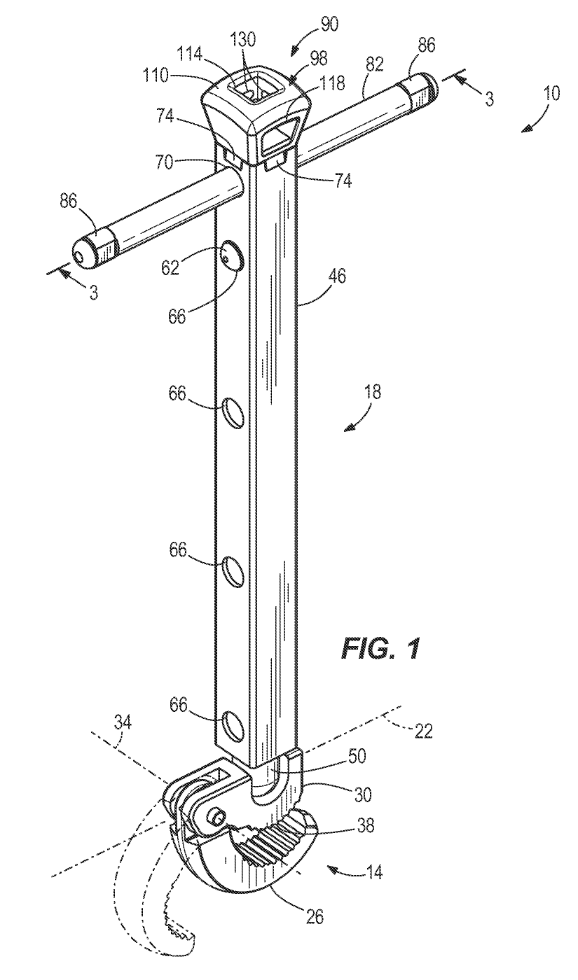

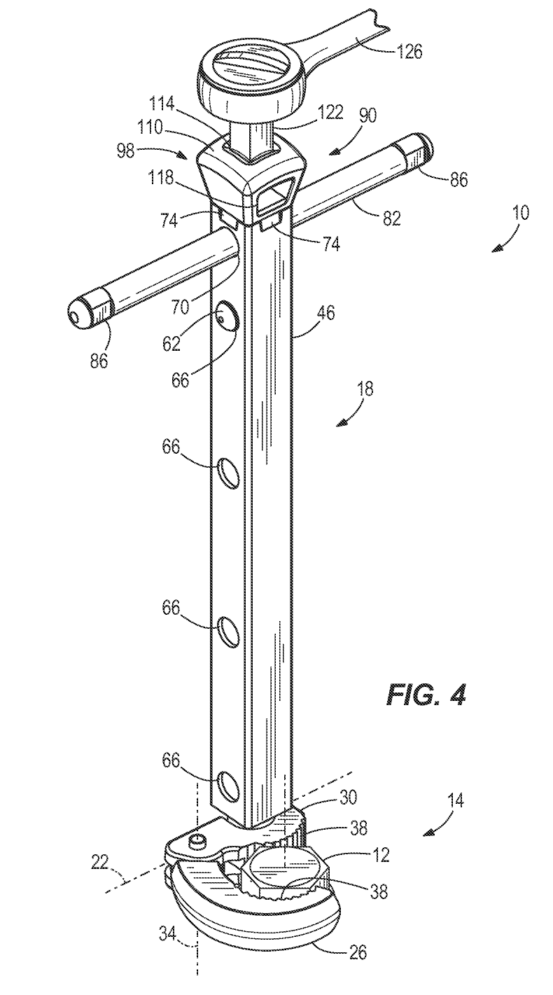

FIG. 1 illustrates a wrench 10 according to one embodiment. In the illustrated embodiment, the wrench 10 is a basin wrench operable as a plumbing tool to rotate a work piece 12, as shown in FIG. 4, in confined spaces. The illustrated work piece 12 may be a fastener, conduit, and the like. The wrench 10 includes a gripping portion 14 and a body portion 18. The gripping portion 14 is rotatable relative to the body portion 18 about a first axis 22. In the illustrated embodiment, the gripping portion 14 is rotatable 180 degrees relative to the body portion 18. The gripping portion 14 includes a hook jaw 26 pivotally moveable relative to a base jaw 30 about a second axis 34. The second axis 34 is perpendicular to the first axis 22. Each jaw 26, 30 includes teeth 38 operable to firmly grip the work piece 12. In particular, the teeth 38 of the hook jaw 26 form a concave profile, and the teeth 38 of the base jaw 30 form a convex profile. In one embodiment, the hook jaw 26 is biased towards the base jaw 30 by a spring (not shown).

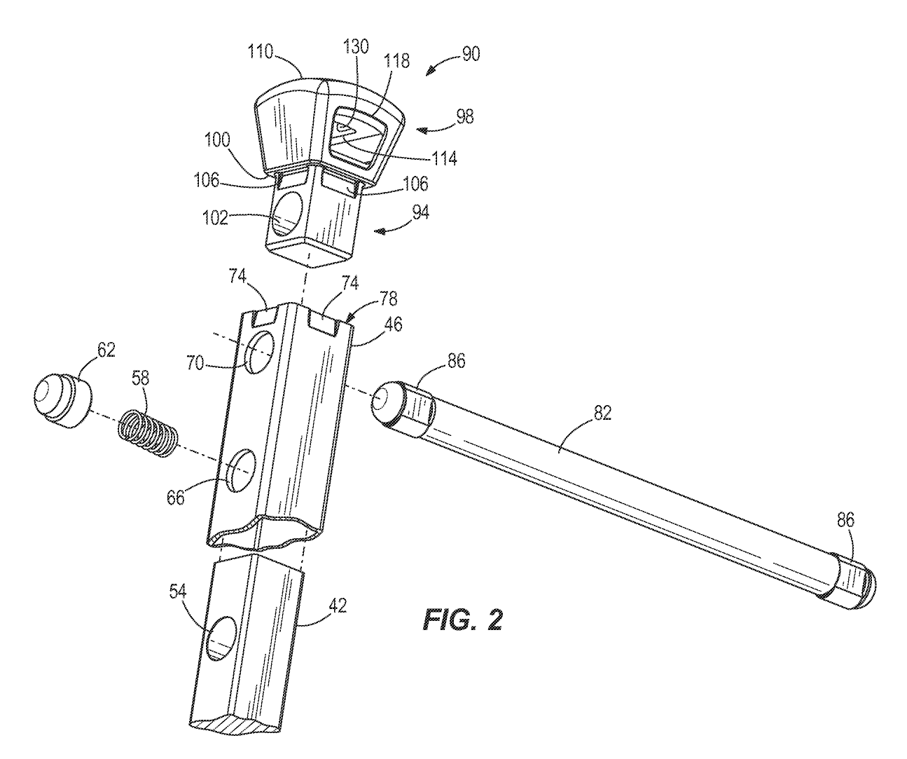

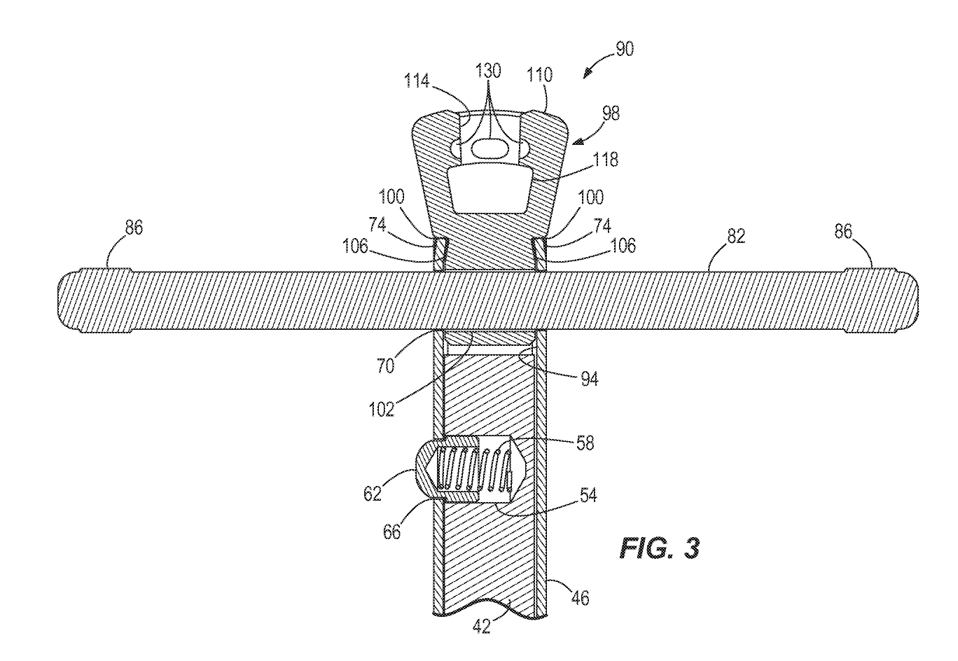

With reference to FIGS. 1 and 2, the body portion 18 includes an inner elongated member 42 and an outer elongated member 46 with both elongated members 42, 46 slidably coupled relative to each other. In the illustrated embodiment, the inner elongated member 42 defines a solid member having a substantially square cross section (e.g., taken parallel to the first axis 22), and the outer elongated member 46 defines a hollow member (e.g., includes an interior portion) also having a substantially square cross section (e.g., taken parallel to the first axis 22). In other words, both the elongated members 42, 46 define two pairs of opposing planar surfaces. In other embodiments, the elongated member 46 may be received within the elongated member 42. In further embodiments, the elongated members 42, 46 may be in other geometries (e.g., a polygon, a rectangle, etc.).

In continued reference to FIGS. 1 and 2, the inner elongated member 42 includes a head portion 50 (i.e., a first end of the body portion 18) that attaches the gripping portion 14 to the inner elongated member 42 with the first axis 22 intersecting the head portion 50. The illustrated head portion 50 is defined as a cylindrical protrusion extending from the inner elongated member 42; however, in other embodiments, the head portion 50 may be defined as a cuboid protrusion. The illustrated inner elongated member 42 also includes a cavity 54 positioned away from the head portion 50. The cavity 50 is sized to receive a biasing member 58 (e.g., a coil spring) and a portion of a detent member 62. In the illustrated embodiment, the detent member 62 includes an internal cavity for the biasing member 58 to be partially received within the detent member 62. In other embodiments, the detent member 62 may be a solid member with the biasing member 58 abutting an exterior surface of the detent member 62.

The illustrated outer elongated member 46 includes detent apertures 66 that align on one planar surface of the outer elongated member 46. In the illustrated embodiment, the outer elongated member 46 includes four equally spaced apart detent apertures 66; however, in other embodiments, the outer elongated member 46 may include more or less than four detent apertures 66. In addition, the detent apertures 66 are sized with a diameter that is less than a major diameter of the detent member 62. The outer elongated member 46 also includes handle apertures 70 and projections 74 with the handle apertures 70 located between the projections 74 and the detent apertures 66. The illustrated handle apertures 70 concentrically extend through opposing surfaces of the outer elongated member 46. In the illustrated embodiment, the outer elongated member 46 includes four projections 74 that extend inwardly into the hollow portion of the outer elongated member 46. Each projection 74 is located at an opening 78 (FIG. 2) of the outer elongated member 46, and each projection 74 extends towards an opposing projection 74. The opening 78 defines a second end of the body portion 18. In other embodiments, the outer elongated member 46 may include more or less than four projections 74. In further embodiments, the projections 74 may be spaced from the opening 78 (e.g., located between the opening 78 and the detent apertures 66).

A handle 82 is sized to be received through the handle apertures 70 and includes stops 86 located on distal ends of the handle 82. The illustrated stops 86 include a major dimension (e.g., diameter) that is greater than the diameter of the handle apertures 70. In the illustrated embodiment, the stops 86 are formed by a manufacturing process that deforms an end portion of the handle 82 to a major dimension that is greater than an original diameter of the handle 82.

With reference to FIG. 2, an end cap 90 includes a first portion 94 that is received within the hollow portion of the outer elongated member 46 through the opening 78. The cap 90 also includes a second portion 98 that extends outside of the hollow portion of the outer elongated member 46 and away from the opening 78. The first portion 94 and the second portion 98 are separated by an intermediate surface 100. The intermediate surface 100 abuts a periphery of the outer elongated member 46 adjacent the opening 78 (FIG. 3). The illustrated first portion 94 includes a handle aperture 102 extending through the first portion 94 with a diameter generally the same as the handle apertures 70 of the outer elongated member 46. In other embodiments, the handle aperture 102 may be replaced with a spring biased detent member, similar to the biasing member 58 and the detent member 62, to selectively engage one of the handle apertures 70. In this embodiment, the cap 90 is removably coupled to the body portion 18. In the illustrated embodiment, recesses 106 are located between the first portion 94 and the second portion 98 and correspond to a projection 74. The recesses 106 also extend into the intermediate surface 100.

The illustrated second portion 98 includes a convex top surface 110 (e.g., the top surface 110 defines a radius). In the illustrated embodiment, the second portion 98 tapers in dimension from the top surface 110 to the intermediate surface 100 (e.g., reduces in dimension from the top surface 110 to the intermediate surface 100). As such, the second portion 98 includes a major dimension that is greater than a periphery of the outer elongated member 46. The second portion 98 also includes a square drive aperture 114 that is oriented perpendicular to the handle 82. In other word, the square drive aperture 114 is oriented parallel to the elongated members 42, 46 (FIG. 3). The square drive aperture 114 is sized to receive a square drive 122 of a tool 126 (e.g., a socket wrench), as shown in FIG. 4. With reference to FIG. 3, the square drive aperture 114 extends between and is in communication with the top surface 110 and a hanging hole 118. The illustrated square drive aperture 114 includes detent grooves 130 with one detent groove 130 located on one side of the square drive aperture 114. The detent grooves 130 are configured to receive a detent mechanism (e.g., spring biased ball) of the square drive 122 to inhibit unintended disconnection between the tool 126 and the cap 90. The illustrated hanging hole 118 is operable to support the wrench 10 on a support member (e.g., nail, hook, lanyard, etc.). In other embodiments, the square drive aperture 114 and/or the hanging hole 118 may be omitted.

During assembly of the cap 90 to the outer elongated member 46, the first portion 94 is received within the outer elongated member 46 such that the handle apertures 70, 102 are concentric, and the intermediate surface 100 abuts an edge of the outer elongated member 46 adjacent the opening 78. The handle 82, which does not include the stops 86 at this time, is slidably received within the handle apertures 70, 102. Then, the stops 86 are formed so that the handle 82 does not inadvertently slide out of the handle apertures 70, 102 during manipulation and transportation of the wrench 10. Once the handle 82 is received within the handle apertures 70, 102, the cap 90 is fixed to the outer elongated member 46. In addition, after the cap 90 is received within the outer elongated member 46, the projections 74 can be formed to engage (e.g., frictional fit) or be displaced towards the recesses 106. In other embodiments, the projections 74 may be formed prior to the cap 90 being received within the outer elongated member 46. In this embodiment, the projections 74 and the recesses 106 form an irreversible snap-fit connection. In further embodiments, the outer elongated member 46 may include the projections 74 and the cap 90 may include the recesses 106. Engagement between the projections 74 and the recesses 106 also affixes the cap 90 to the outer elongated member 46. In other embodiments, the handle 82 may be omitted, but the cap 90 remains fixed to the outer elongated member 46 by the engagement between the projections 74 and the recesses 106. In further embodiments, the projections 74 and the recesses 106 may be omitted, but the cap 90 remains fixed to the outer elongated member 46 by the handle 82 received within the handle apertures 70, 102.

In operation, the elongated members 42, 46 can slide or telescope relative to each other thereby providing different overall lengths of the wrench 10. For example, the wrench 10 may adjust to lengths from about 10 inches to about 17 inches. By depressing the detent member 62 into the cavity 54 and then moving the elongated members 42, 46 relative to each other, an operator can adjust the length of the wrench 10 by aligning the detent member 62 within any of the detent apertures 66. Because the detent member 62 includes a major diameter greater than the diameter of the detent apertures 66 (FIG. 3), a portion of the detent member 62 abuts an interior surface of the outer elongated member 46 so that only a portion of the detent member 62 extends through a detent aperture 66.

With reference to FIG. 4, the jaws 26, 30 are manipulated to grip the work piece 12. In particular, the hook jaw 26 is pivoted about the second axis 34 relative to the fixed jaw 30 to grip different sized work pieces. The work piece 12 can be rotated in either direction (e.g., to tighten or loosen the work piece 12) by the operator utilizing the handle 82 or the socket wrench 126. When the handle 82 is used, a palm of the operator's hand abuts the top surface 110 of the cap 90. Consequently, the operator's palm does not directly contact the body portion 18 to provide comfort and an ergonomic grip to the operator using the wrench 10. The handle 82 is then used to provide additional torque or mechanical advantage to the gripping portion 14 when the operator rotates the wrench 10. The handle 82 can be used as a T-handle, as illustrated in FIG. 4, with equal portions of the handle 82 extending from opposing sides of the body portion 18. In other embodiments, one of the stops 86 can abut the body portion 18 so that a majority of the handle 82 extends from one side of the body portion 18.

Alternatively, if the socket wrench 126 is coupled to the cap 90 by engagement between the square drive 122 and the square drive aperture 114, the socket wrench 126 provides additional torque or mechanical advantage to the gripping portion 14 when the operator rotates the socket wrench 126. The square drive aperture 114 can be sized to receive different sized square drives 122 (e.g., 1/4″ square drive, ⅜″ square drive, ½″ square drive, etc.). In addition, the socket wrench 126 provides a ratcheting mechanism to continuously rotate the work piece 12 without repositioning the gripping portion 14 on the work piece 12 or repositioning the operator's hand on the cap 90 and the handle 82.

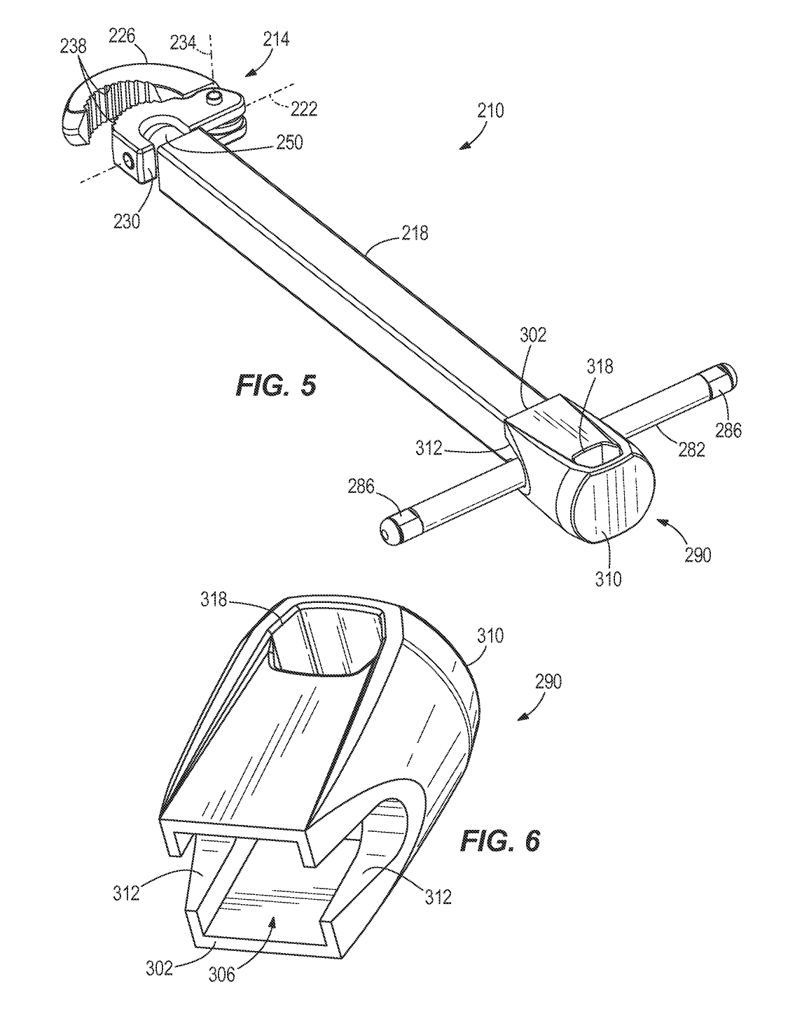

FIGS. 5 and 6 illustrate a wrench 210 according to another embodiment. The wrench 210 is similar to the wrench 10; therefore, like components have been given like reference numbers plus 200 and only differences between the wrenches 10 and 210 will be discussed in detail. In addition, components or features described with respect to only one or some of the embodiments described herein are equally applicable to any other embodiments described herein.

The illustrated wrench 210 includes a gripping portion 214 having a hook jaw 226 pivotally coupled to a fixed jaw 230 about an axis 234. Each jaw 226, 230 includes teeth 238. The gripping portion 214 is pivotally coupled to a head portion 250 of a body portion 218 about an axis 222. In the illustrated embodiment, the body portion 218 is defined by one solid elongated member, thereby providing the wrench 210 with a fixed overall length. The body portion 218 includes a handle aperture that receives a handle 282 having stops 286.

An end cap 290 includes a planar top surface 310, a bottom surface 302, and a cavity 306 adjacent the bottom surface 302. The illustrated cavity 306 is sized to receive an outer periphery of the body portion 218. In the illustrated embodiment, the cavity 302 provides a frictional fit with the body portion 218 to affix the cap 290 to the body portion 218. In other embodiments, the cap 290 may be coupled to the body portion 218 by an adhesive, or the cap 290 may be removably coupled to the body portion 218. In the illustrated embodiment, openings 312 are located on opposite sides of the cap 290 and are in communication with the cavity 302. The illustrated openings 312 are sized to slide over the handle 282 when the cap 290 is inserted onto the body portion 218. In other embodiments, the openings 312 may be constructed as circular apertures, so the handle 282 may also function to secure the cap 290 to the body portion 218 (similar to the engagement between the handle 82 and the handle aperture 102, as described above). The cap 290 also includes a hanging hole 318.

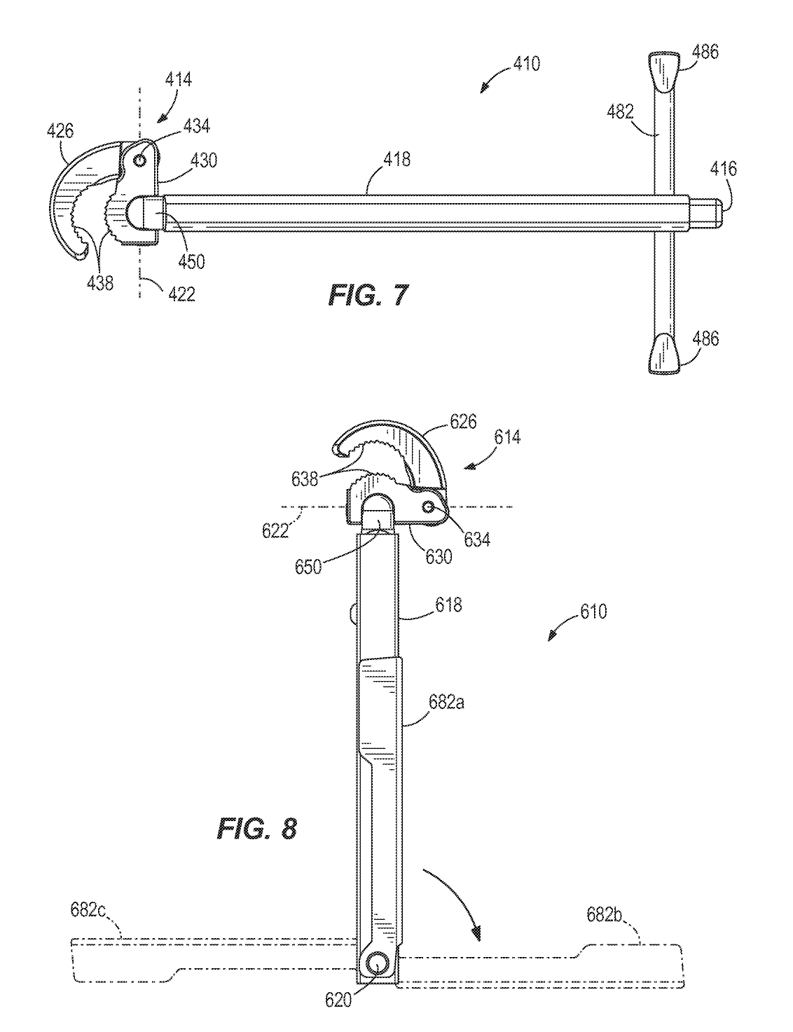

FIG. 7 illustrates a wrench 410 according to another embodiment. The wrench 410 is similar to the wrench 10; therefore, like components have been given like reference numbers plus 400 and only differences between the wrenches 10 and 410 will be discussed in detail. In addition, components or features described with respect to only one or some of the embodiments described herein are equally applicable to any other embodiments described herein.

The illustrated wrench 410 includes a gripping portion 414 having a hook jaw 426 pivotally coupled to a fixed jaw 430 about an axis 434. Each jaw 426, 430 includes teeth 438. The gripping portion 414 is pivotally coupled to a head portion 450 of a body portion 418 about an axis 422. In the illustrated embodiment, the body portion 418 is defined by an octagonal elongated member. The body portion 418 includes a handle aperture that receives a handle 482 having stops 486. The illustrated body portion 418 includes a hexagonal stud 416 extending away from the gripping portion 414. The hexagonal stud 416 is configured to receive a drive socket (e.g., a drive socket coupled to the square drive 122 of the socket wrench 126).

FIG. 8 illustrates a wrench 610 according to another embodiment. The wrench 610 is similar to the wrench 10; therefore, like components have been given like reference numbers plus 600 and only differences between the wrenches 10 and 610 will be discussed in detail. In addition, components or features described with respect to only one or some of the embodiments described herein are equally applicable to any other embodiments described herein.

The illustrated wrench 610 includes a gripping portion 614 having a hook jaw 626 pivotally coupled to a fixed jaw 630 about an axis 634. Each jaw 626, 630 includes teeth 638. The gripping portion 614 is pivotally coupled to a head portion 650 of a body portion 618 about an axis 622. A handle 682 is pivotally coupled to the body portion 618 about a third axis 620. The third axis 620 is parallel and transverse to the axis 622. In other embodiments, the third axis 620 may be parallel and coplanar with the axis 622. The handle 682 pivots relative to the body portion 618 about 270-degrees. For example, when the handle 682 is in a first position referenced at 682a, the handle 682a is oriented at 0-degrees relative to the body portion 618. When the handle 682 is rotated in a second position referenced at 682b, the handle 682b is oriented at about 90-degrees relative to the body portion 618. When the handle 682 is rotated in a third position referenced at 682c, the handle 682 is oriented at about 270-degrees relative to the body portion 618. In the illustrated embodiment, the handle 682 is received over three sides of the body portion 618. In other words, the handle 682 includes a cross section generally defined as a U-shaped channel. In other embodiments, the cross section of the handle 682 may define an L-shape channel such that the handle 682 is received on two sides of the body portion 618.

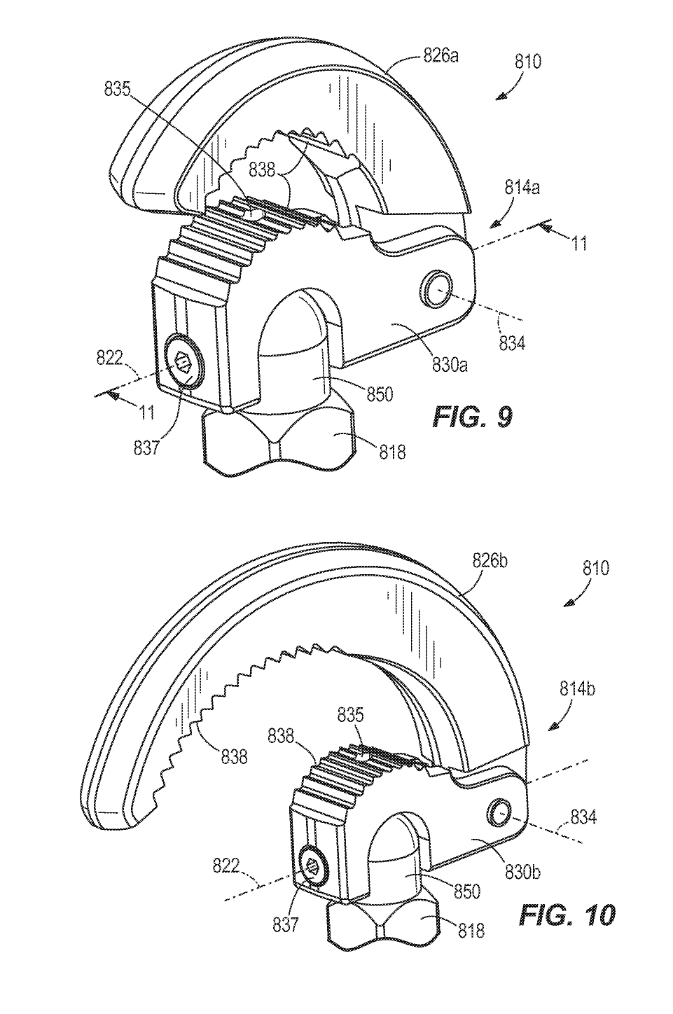

FIGS. 9-13 illustrate a wrench 810 according to another embodiment. The wrench 810 includes features similar to the wrench 10; therefore, like components have been given like reference numbers plus 800 and only differences between the wrenches 10 and 810 will be discussed in detail. In addition, components or features described with respect to only one or some of the embodiments described herein are equally applicable to any other embodiments described herein.

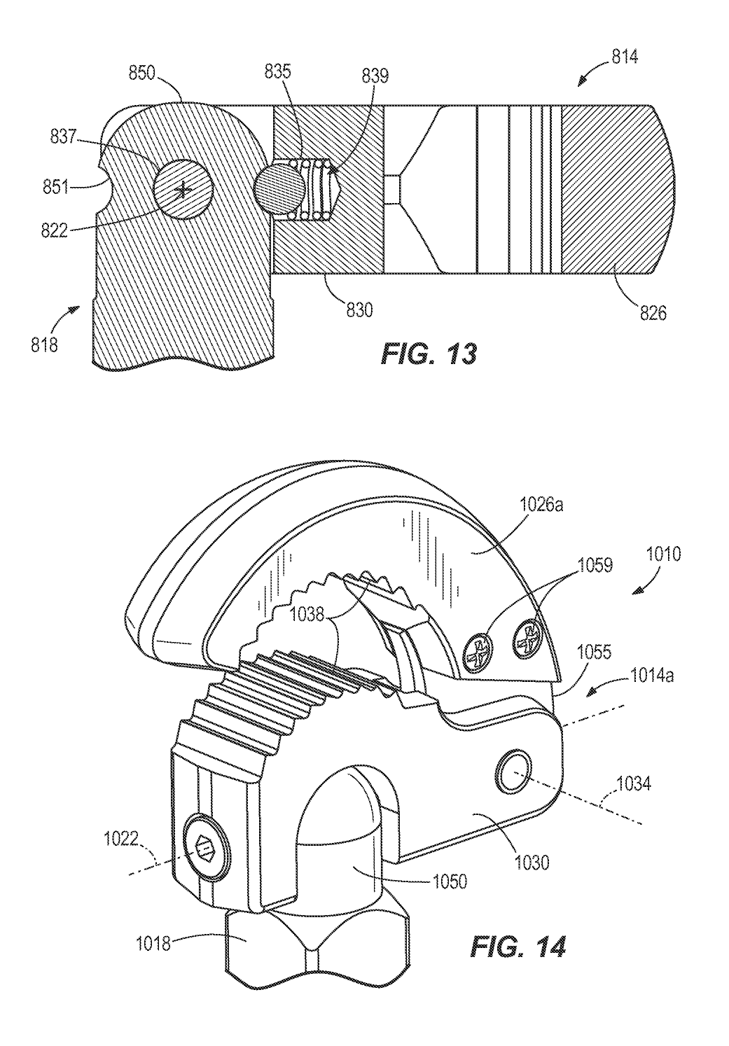

With reference to FIG. 9, the illustrated wrench 810 includes a first gripping assembly 814a having a first hook jaw 826a pivotally coupled to a first fixed jaw 830a about an axis 834. Each jaw 826a, 830a includes teeth 838. The illustrated fixed jaws 830a, 830b include an aperture 835 (FIG. 11) extending through the fixed jaws 830a, 830b. In other embodiments, the aperture 835 may partially extend through the fixed jaws 830a, 830b to open away from the teeth 838 (FIG. 13).

The first gripping assembly 814a is pivotally coupled to a head portion 850 of a body portion 818 about an axis 822 by a fastener 837. The fastener 837 enables different gripping assemblies to be removed and replaced onto the body portion 818. By removing the fastener 837, the first gripping assembly 814a, which includes the first hook jaw 826a and the first fixed jaw 830a, is removed from the head portion 850.

With reference to FIG. 10, a second gripping assembly 814b is coupled to the head portion 850 by the fastener 837 after the first gripping assembly 814a is removed. In the illustrated embodiment, the second gripping assembly 814b includes a larger hook jaw 826b than the first hook jaw 826a, but the hook jaws 830a, 830b remain generally the same size. In other embodiments, the hook jaws 830a, 830b may be different in size.

With reference to FIG. 11, the aperture 835 receives a detent assembly 839 including a housing 843 threaded into engagement with an inner profile of the aperture 835 and a detent 847. The illustrated detent 847 may be a spherical member or a cylindrical member that is biased from the housing 843 to engage the head portion 850. In some embodiments, the head portion 850 may include a recess that receives the detent 847. The illustrated detent assembly 839 allows the gripping portion 814 to be located in a certain orientation relative to the body portion 818. For example, the detent assembly 839 allows the gripping portion 814 to be biased parallel to the body portion 818 (FIG. 9), or allows the gripping portion 814 to be biased perpendicular to the body portion 818 (FIG. 13).

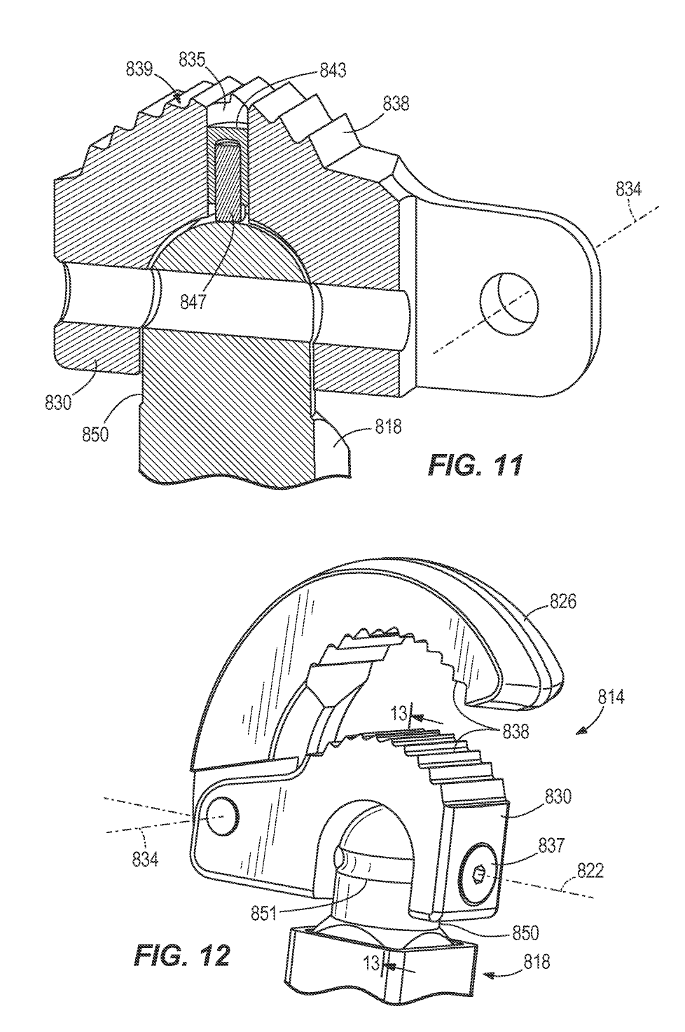

With reference to FIGS. 12 and 13, the head portion 850 may include a groove 851 extending around a circumference of the head portion 850. In other embodiments, the groove 851 may not be continuous around the circumference of the head portion 850. For example, a plurality of grooves 851 may be located on the head portion 850. The illustrated groove 851 receives the detent assembly 839, which is illustrated as a detent ball and a spring in FIG. 13, to bias the gripping portion 814 perpendicular to the body portion 818.

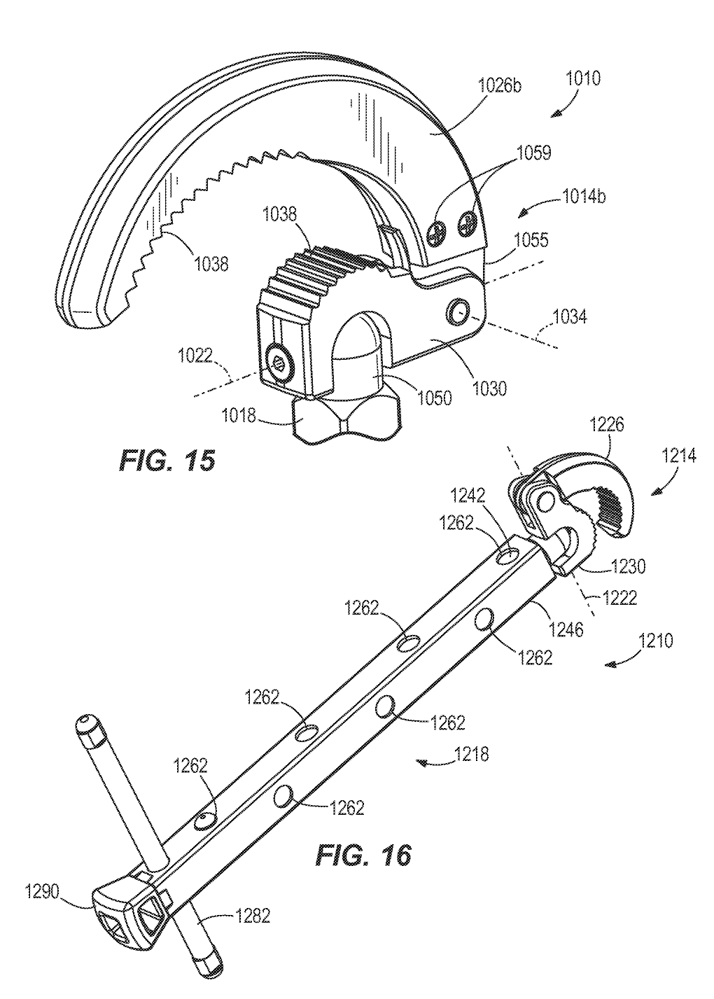

FIGS. 14 and 15 illustrate a portion of a wrench 1010 according to another embodiment. The wrench 1010 includes features similar to the wrench 10; therefore, like components have been given like reference numbers plus 1000 and only differences between the wrenches 10 and 1010 will be discussed in detail. In addition, components or features described with respect to only one or some of the embodiments described herein are equally applicable to any other embodiments described herein.

With reference to FIG. 14, the illustrated wrench 1010 includes a first gripping assembly 1014a having a fixed jaw 1030 pivotally coupled to an intermediate portion 1055 about an axis 1034. The illustrated intermediate portion 1055 couples a first hook jaw 1026a to the fixed jaw 1030 by fasteners 1059 so that the first hook jaw 1026a is also rotatable about the axis 1034. Each jaw 1026a, 1030a includes teeth 1038. The first gripping assembly 1014a is pivotally coupled to a head portion 1050 of a body portion 1018 about an axis 1022.

In the illustrated embodiment, the first hook jaw 1026a may be removed from the intermediate portion 1055 and replaced with a second hook jaw 1026b (FIG. 15). In particular, the first hook jaw 1026a is removed from the intermediate portion 1055 by removing the fasteners 1059. The fixed jaw 1030 remains attached to the head portion 1050 as the first hook jaw 1026a is removed. The second hook jaw 1026b is then received on the intermediate portion 1055 for the fasteners 1059 to engage the second hook jaw 1026b and the intermediate portion 1055 to secure the second hook jaw 1026b to the hook jaw 1030.

FIG. 16 illustrates a wrench 1210 according to another embodiment. The wrench 1210 includes features similar to the wrench 10; therefore, like components have been given like reference numbers plus 1200 and only differences between the wrenches 10 and 1210 will be discussed in detail. In addition, components or features described with respect to only one or some of the embodiments described herein are equally applicable to any other embodiments described herein.

The illustrated wrench 1210 includes a gripping portion 1214 having jaws 1226, 1230 pivotally coupled to a body portion 1218 about an axis 1222. A cap 1290 and a handle 1282 are coupled to the body portion 1218. The illustrated body portion 1218 includes an inner elongated member 1242 slidably received with an outer elongated member 1246. Both elongated members 1242, 1246 define four planar surfaces. The inner elongated member 1242 includes a detent member 1262 that selectively engages a detent aperture 1262 located on a planar surface of the outer elongated member 1246. The illustrated outer elongated member 1246 includes three detent apertures 1262 located on one planar surface and three detent apertures 1262 located on an adjacent planar surface. Therefore, the six detent apertures 1262 provide six different lengths of the wrench 1210. By locating the detent apertures 1262 on different planar surfaces instead of on one planar surface, the structural integrity of the outer elongated member 1246 is maintained as the wrench 1210 rotates the work piece 12. In other embodiments, the outer elongated member 1246 may include more or less than three detent apertures 1262 on a planar surface.

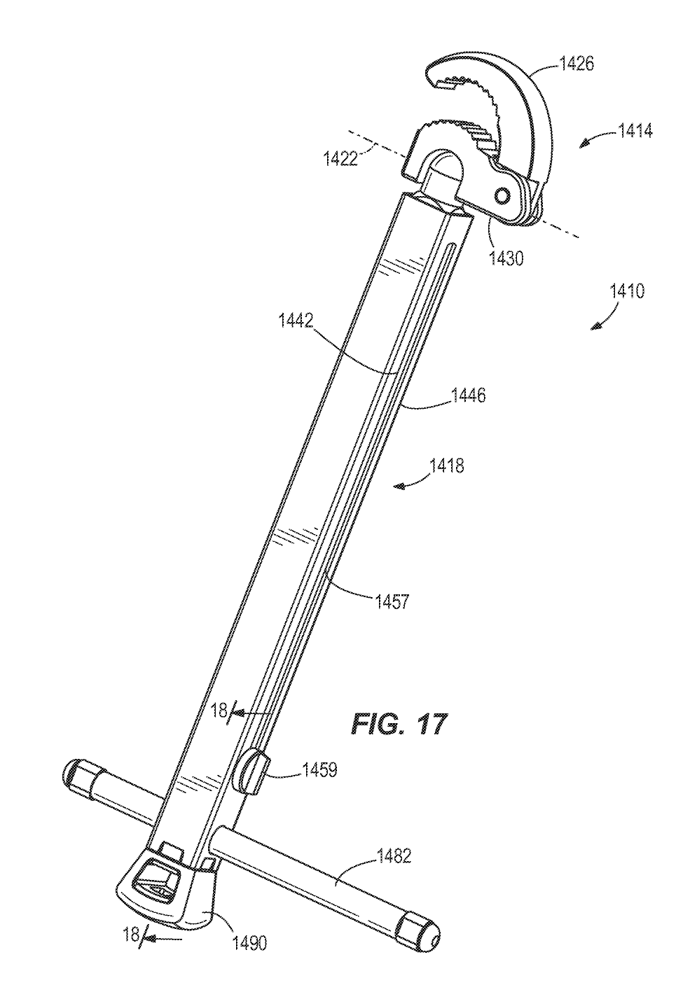

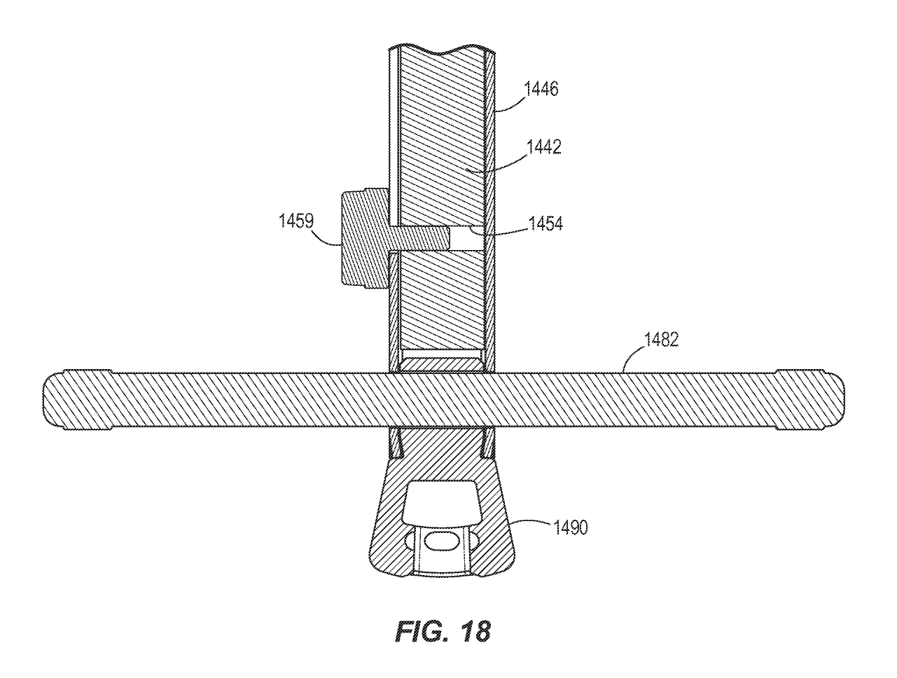

FIGS. 17 and 18 illustrate a wrench 1410 according to another embodiment. The wrench 1410 includes features similar to the wrench 10; therefore, like components have been given like reference numbers plus 1400 and only differences between the wrenches 10 and 1410 will be discussed in detail. In addition, components or features described with respect to only one or some of the embodiments described herein are equally applicable to any other embodiments described herein.

The illustrated wrench 1410 includes a gripping portion 1414 having jaws 1426, 1430 pivotally coupled to a body portion 1418 about an axis 1422. A cap 1490 and a handle 1482 are coupled to the body portion 1418. The illustrated body portion 1418 includes an inner elongated member 1442 slidably received with an outer elongated member 1446. The inner elongated member 1442 includes a threaded aperture 1454 (FIG. 18), and the outer elongated member 1446 includes a slot 1457. A lock 1459 is received through the slot 1457 to threadably engage the threaded aperture 1454. The illustrated lock 1459 is rotatable to lock the elongated members 1442, 1446 relative to each other to adjust the length of the wrench 1410.

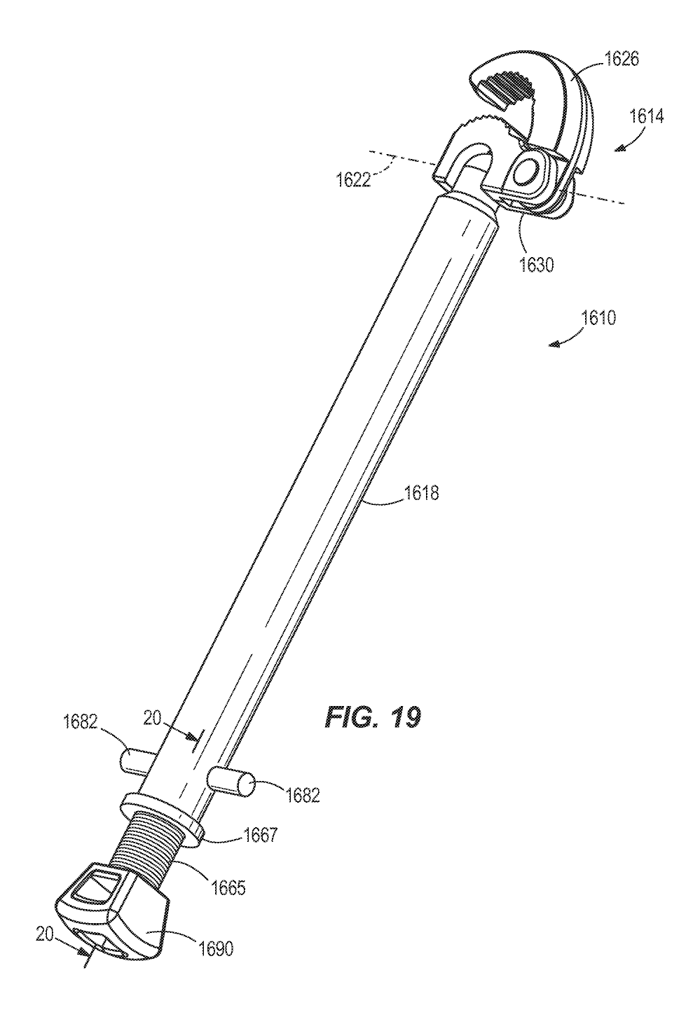

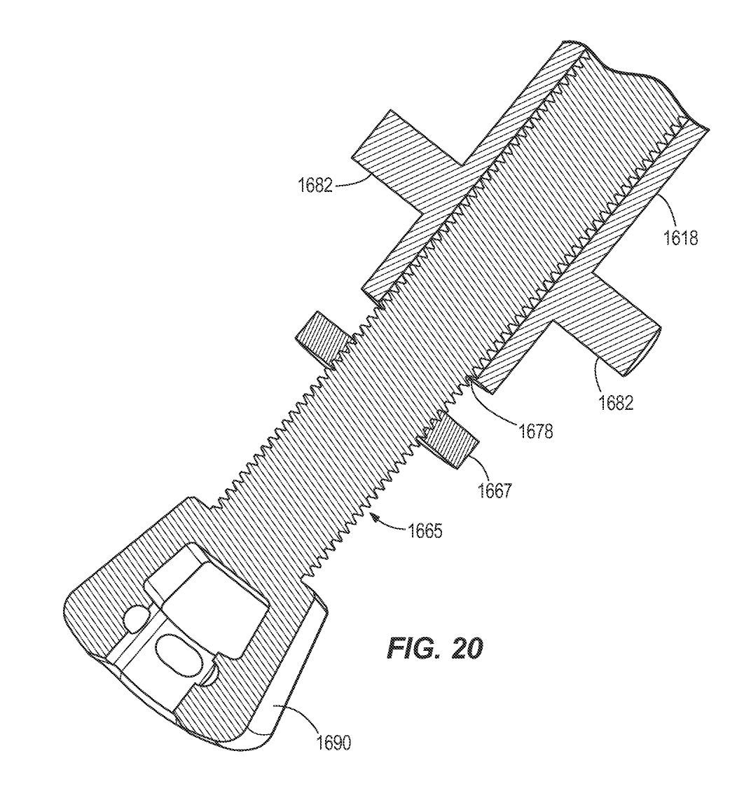

FIGS. 19 and 20 illustrate a wrench 1610 according to another embodiment. The wrench 1610 includes features similar to the wrench 10; therefore, like components have been given like reference numbers plus 1600 and only differences between the wrenches 10 and 1610 will be discussed in detail. In addition, components or features described with respect to only one or some of the embodiments described herein are equally applicable to any other embodiments described herein.

The illustrated wrench 1610 includes a gripping portion 1614 having jaws 1626, 1630 pivotally coupled to a body portion 1618 about an axis 1622. A cap 1690 and a handle 1682 are coupled to the body portion 1618 away from the gripping portion 1614. The illustrated cap 1690 includes a threaded portion 1665 that threadably engages an interior of the body portion 1618 through an opening 1678 (FIG. 20). Thus, the cap 1690 is rotatable relative to the body portion 1618 to adjust the overall length of the wrench 1610. The cap 1690 is locked in position by rotating a lock nut 1667 against the body portion 1618 adjacent the opening 1678.

Although the invention has been described in detail with reference to certain preferred embodiments, variations and modifications exist within the scope and spirit of one or more independent aspects of the invention as described.

1. A wrench comprising:
a first jaw;
a second jaw movable relative to the first jaw about a first axis, the first and the second jaws configured to grip a work piece;
a body pivotally coupled to the first and the second jaws about a second axis, the body including an interior portion, a first end, and a second end, the first end is adjacent the first and the second jaws, the second end including an opening; and
a cap including a first portion and a second portion, the first portion is received within the interior portion of the body through the opening, the second portion extending outside of the body and away from the opening, the second portion including a square drive aperture configured to receive a square drive of a tool.

2. The wrench of claim 1, wherein the square drive aperture includes a detent groove configured to receive a portion of the square drive the tool.

3. The wrench of claim 1, wherein the cap includes a hanging hole in communication with the square drive aperture, and wherein hanging hole is configured to support the wrench on a support member.

4. The wrench of claim 1, wherein the cap includes an intermediate surface positioned between the first portion and the second portion, and wherein the intermediate surface abuts a periphery of the body.

5. The wrench of claim 1, wherein the second portion of the cap includes a convex top surface facing away from the first portion of the cap.

6. The wrench of claim 5, wherein the cap tapers from the convex top surface to an intermediate surface defined between the first portion and the second portion of the cap.

7. The wrench of claim 1, wherein the cap includes a recess that engages a projection located on the body to secure the cap to the body.

8. The wrench of claim 1, wherein the first portion of the cap includes a first handle aperture that aligns with second handle apertures located on the body, and wherein the first and second handle apertures receive a handle to secure the cap to the body.

9. The wrench of claim 1, wherein the body includes an inner elongated member slidably received within an outer elongated member, and wherein the inner elongated member is coupled to the first jaw and the outer elongated member is coupled to the cap.

10. The wrench of claim 9, wherein the inner elongated member includes a cavity that receives a biasing member and a detent member, the outer elongated member includes a plurality of detent apertures, and wherein the detent member selectively engages one of the detent apertures to adjust a length of the wrench.

11. A wrench comprising:
a first jaw;
a second jaw movable relative to the first jaw about a first axis, the first and the second jaws configured to grip a work piece;
a body pivotally coupled to the first and the second jaws about a second axis, the body including an interior portion, a first end, and a second end, the first end is adjacent the first and the second jaws, the second end including an opening, the body further including first handle apertures positioned adjacent the opening;
a cap including a first portion and a second portion, the first portion is received within the interior portion of the body through the opening, the first portion including a second handle aperture, the second portion extending outside of the body and away from the opening; and
a handle received through the first and the second handle apertures to secure the cap to the body.

12. The wrench of claim 11, wherein the handle includes a stop located on each end of the handle, and wherein the handle is slidable relative to the body in a direction until one of the stops abuts a portion of the body.

13. The wrench of claim 11, wherein the second portion of the cap includes a convex top surface facing away from the first portion of the cap.

14. The wrench of claim 13, wherein the convex top surface is configured to abut an operator's hand as the operator grips the handle to rotate the first and second jaws to rotate the work piece.

15. The wrench of claim 11, wherein the second portion of the cap includes a square drive aperture configured to receive a square drive of a tool.

16. A wrench comprising:
a first jaw;
a second jaw movable relative to the first jaw about a first axis, the first and the second jaws configured to grip a work piece;
a body pivotally coupled to the first and the second jaws about a second axis, the body including an interior portion, a first end, and a second end, the first end is adjacent the first and the second jaws, the second end including an opening, the body further including a projection adjacent the opening extending into the interior portion of the body; and
a cap including a first portion and a second portion, the first portion is received within the interior portion of the body through the opening, the first portion including a recess, the second portion extending outside of the body and away from the opening;
wherein engagement between the projection and the recess secures the cap to the body.

17. The wrench of claim 16, wherein the body includes four projections and the cap includes four recesses.

18. The wrench of claim 16, wherein the cap includes an intermediate surface positioned between the first portion and the second portion, and wherein the intermediate surface abuts a periphery of the body.

19. The wrench of claim 16, wherein the cap includes a major dimension that is greater than a periphery of the body.

20. The wrench of claim 16, wherein the second portion of the cap includes a square drive aperture configured to receive a square drive of a tool.
